(19) United States
(12) Patent Application Publication
(10) Pub. No.: US 2006/0131824 A1
(43) Pub. Date: Jun. 22, 2006

(54) Readily controllable skateboard, snowboard, surfboard, and the like

(76) Inventor: Thomas K. Hong, Toronto (CA)

Correspondence Address: THOMAS K. HONG, 1666 Queen Street East, Unit 18, TORONTO, ON, M4L1G3, CA

(21) Appl. No.: 11/016,957

(22) Filed: Dec. 21, 2004

(51) Int. Cl. B62B 9/04

(52) U.S. Cl. 280/14.27

(57) ABSTRACT

A readily controllable skateboard comprises a board having a top side and an under side. A front wheel carriage and a rear wheel carriage are mounted in downwardly extending relation on the under side of the board. A “U”-bolt is secured to the board so as to be generally centrally located along the length and across the width of the board. A strap has a top end and a bottom end, and is connected adjacent its bottom end to the connector so as to be extendable upwardly from the board means. A handle is connected to the top end of the strap.

### FIELD OF THE INVENTION

The present invention relates to skateboards, snowboards, surfboards and the like and more particularly to skateboards, snowboards, surfboards and the like that are readily controllable.

### BACKGROUND OF THE INVENTION

Skateboards have been known for years and typically consist of a generally flat board with upturn front and back ends, and a pair of wheels mounted adjacent each of the front and back ends. A rider places one foot on the skateboard and propels himself along by pushing with the other foot on the ground. Once a rider has reached a desired speed, both feet are placed on the skateboard in a spaced apart stance. Skateboards are typically about perhaps two feet long by eight to ten inches wide so as to be large enough to readily accommodate a rider's feet in a spaced apart stance.

Learning to ride a skateboard can be difficult, and it is very common for a novice rider to fall off the skateboard frequently. Even experienced riders can fall off when performing advanced manoeuvres.

Commonly, skateboard riders also perform many various types of tricks, many of which tricks require the front or back end of the skateboard to be lifted. For most skateboards, this requires pushing downwardly on the front or back of the skateboard in order to make the opposite end of the skateboard go up. However, this is difficult to do and requires a reasonable amount of skill. Alternatively, the skateboard may be lifted by the rider's hands, which is difficult and requires a crouched position.

Further, some stunts, such as jumping over objects, requires the skateboard to be elevated a considerable distance. This is quite difficult and requires that the back end of the skateboard be forced downwardly, and then, when the front end of the skateboard is in the air, the front end of the skateboard is kicked downwardly, thus bring the back end up. This manoeuver is obviously difficult to control.

Also learning to ride other types of “ride-on” boards such as snowboards and surfboards can be difficult, and performing advanced manoeuvres on such “ride-on” boards inevitably results in losing control of the board.

What is needed is a means for controlling a “ride-on” board, such as a skateboard, snowboard, surfboard, and the like.

U.S. Pat. No. 4,289,325 issued Sep. 15, 1981 to Whitacre, discloses a Skateboard. This skateboard has a forward extension and a support rope secured to the forward portion of the skateboard. The support rope has a handle at its top end for grasping by a rider of the skateboard. In use, the rope is angle rearwardly and upwardly. Accordingly, pulling on the rope also pulls the rider forwardly, thus compromising the rider's balance, which is undesirable.

U.S. Pat. No. 5,020,827 issued Jun. 4, 1991 to Murdoch, discloses a Skating Bridle. This elastic bridle is attachable to the side edges of a skateboard. A skateboard having this elastic bridle attached to it has at least two drawbacks associated with it. Firstly, the elastic bridle can pull up on one edge more than the others which would cause the skateboard to pivot on its longitudinal axis. Secondly, the elastic bridle spans across the width of the skateboard, thus getting in the way of a rider.

It is an object of the present invention to provide a readily controllable ride-on board, such as a skateboard, snowboard, surfboard, and the like.

It is an object of the present invention to provide a readily controllable ride-on board, such as a skateboard, snowboard, surfboard, and the like, which ride-on board provides for increased control over prior art boards.

### SUMMARY OF THE INVENTION

In accordance with one aspect of the present invention there is disclosed a novel readily controllable skateboard comprising a board means having a length and a width, and a top surface and an bottom surface. A front wheel carriage and a rear wheel carriage are mounted in downwardly extending relation on the bottom surface of the board means. A connector means is secured to the board means so as to be generally centrally located along the length and across the width of the board means. A strap means has a top end and a bottom end, and is connected adjacent its bottom end to the connector means so as to be extendable upwardly from the board means.

In accordance with another aspect of the present invention there is disclosed a novel readily controllable ride-on board comprising a board means having a top side and an under side. A connector means is secured to the board means so as to be generally centrally located along the length and across the width of the board means. A strap means has a top end and a bottom end, and is connected adjacent its bottom end to the connector means so as to be extendable upwardly from the board means.

Other advantages, features and characteristics of the present invention, as well as methods of operation and functions of the related elements of the structure, and the combination of parts and economies of manufacture, will become more apparent upon consideration of the following detailed description and the appended claims with reference to the accompanying drawings, the latter of which is briefly described herein below.

### BRIEF DESCRIPTION OF THE DRAWINGS

The novel features which are believed to be characteristic of the readily controllable skateboard, snowboard, surfboard, and the like according to the present invention, as to its structure, organization, use and method of operation, together with further objectives and advantages thereof, will be better understood from the following drawings in which a presently preferred embodiment of the invention will now be illustrated by way of example. It is expressly understood, however, that the drawings are for the purpose of illustration and description only, and are not intended as a definition of the limits of the invention. In the accompanying drawings:

FIG. 1 is a perspective view of a preferred embodiment readily controllable skateboard according to the present invention;

FIG. 2 is a top plan view of the preferred embodiment readily controllable skateboard of FIG. 1;

FIG. 3 is a bottom plan view of the preferred embodiment readily controllable skateboard of FIG. 1;

FIG. 4 is a side elevational view of the preferred embodiment readily controllable skateboard of FIG. 1;

FIG. 5 is a front elevational view of the preferred embodiment readily controllable skateboard of FIG. 1;

FIG. 6 is a back elevational view of the preferred embodiment readily controllable skateboard of FIG. 1;

FIG. 7 is an enlarged top plan view of a central portion of the preferred embodiment readily controllable skateboard of FIG. 1;

FIG. 8 is an enlarged bottom plan view of a central portion of the preferred embodiment readily controllable skateboard of FIG. 1;

FIG. 9 is an enlarged cross-sectional side elevational view of a central portion of the preferred embodiment readily controllable skateboard of FIG. 1, taken along section line 9-9 of FIG. 7; and;

FIG. 10 is a perspective view of a preferred embodiment readily controllable snowboard according to the present invention.

### DETAILED DESCRIPTION OF THE PREFERRED EMBODIMENTS

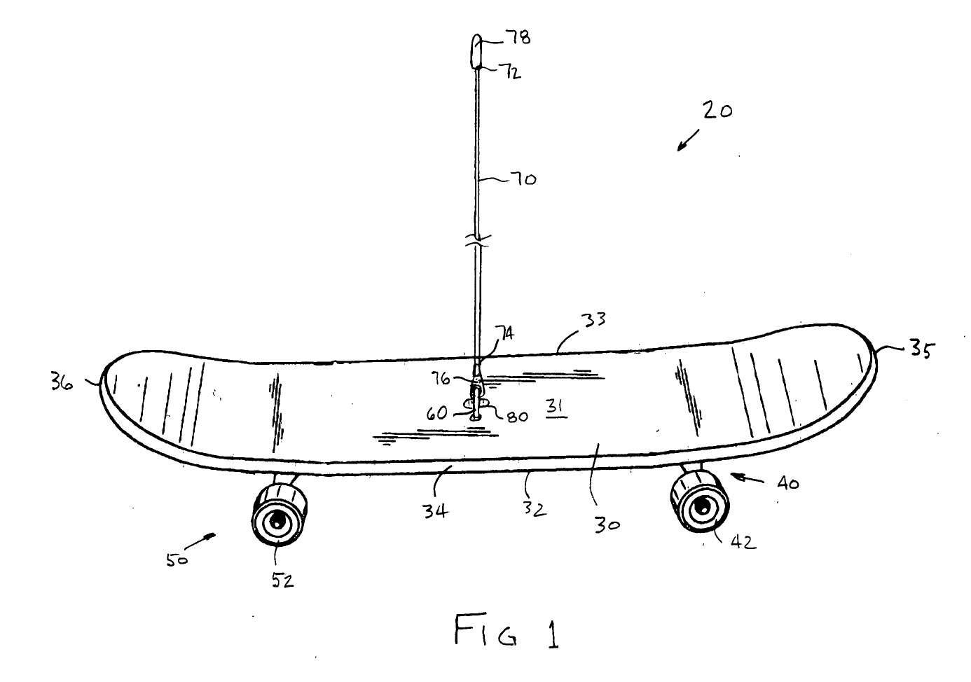

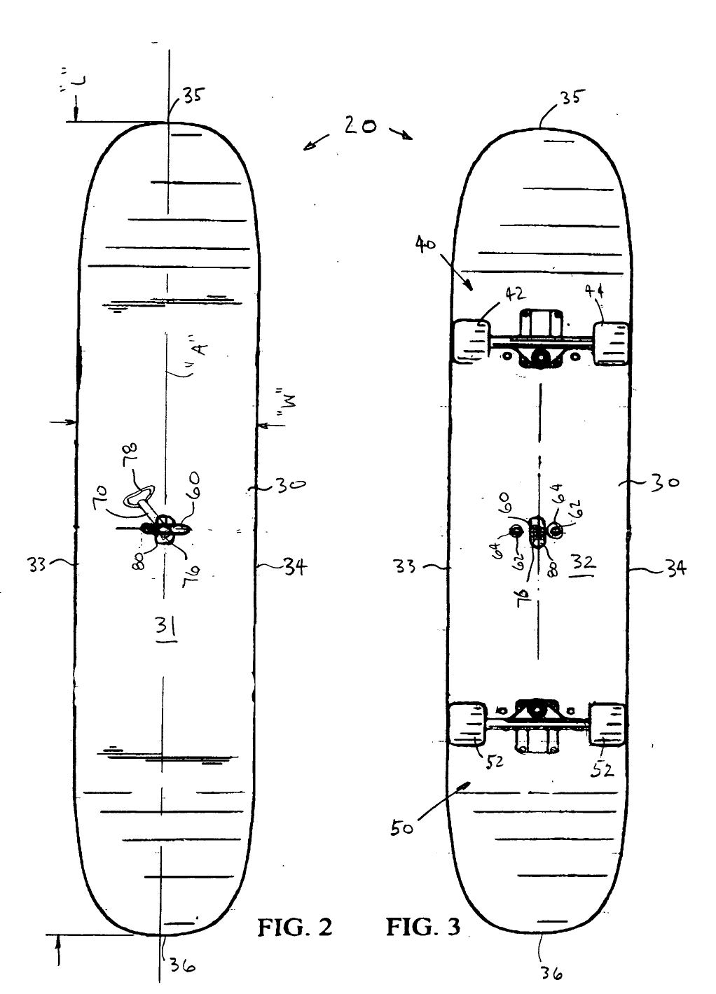

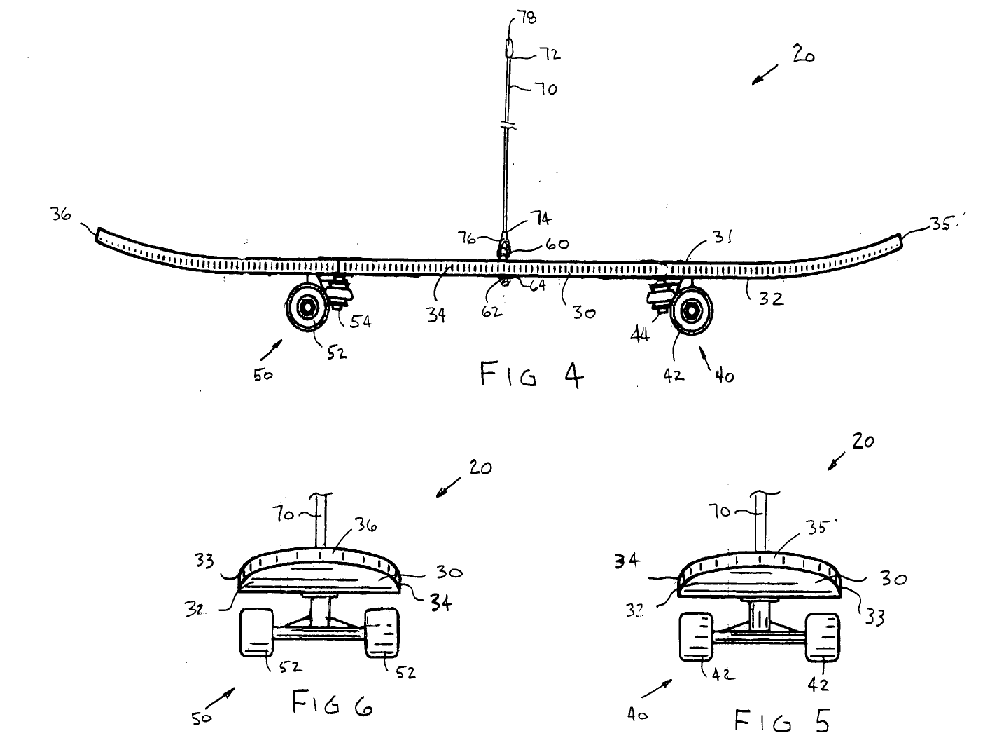

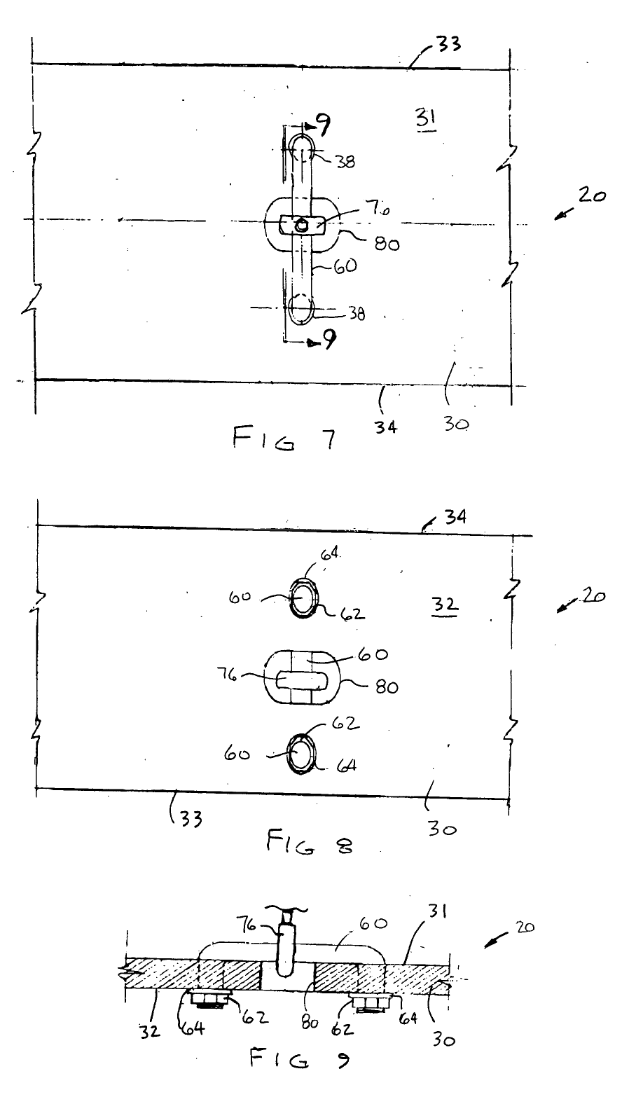

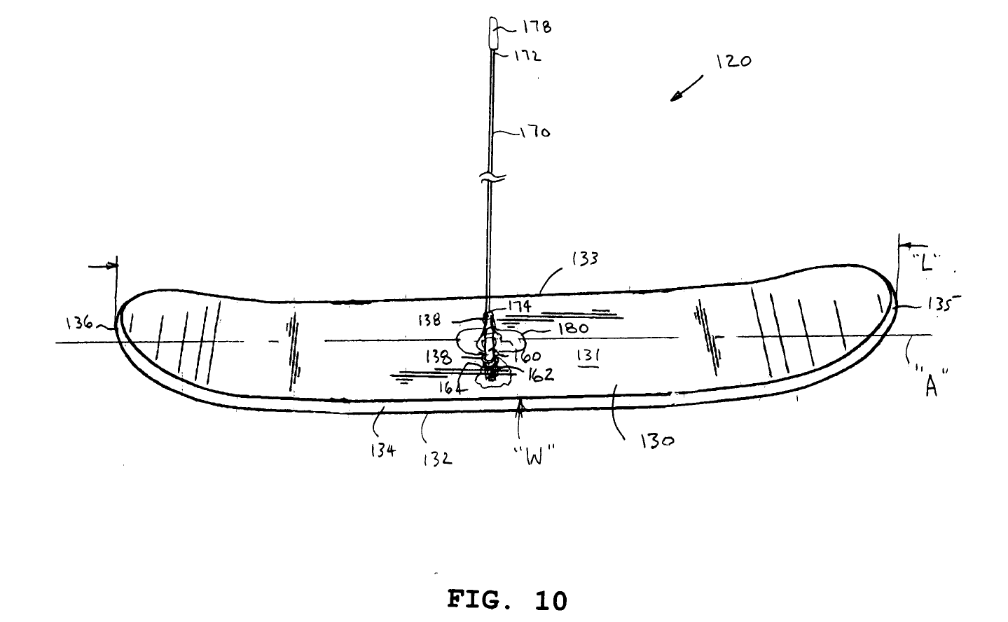

Referring to FIGS. 1 through 10 of the drawings, it will be noted that FIGS. 1 through 9 illustrate a preferred embodiment of the readily controllable skateboard of the present invention, and FIG. 10 illustrates a second preferred embodiment of the readily controllable skateboard of the present invention.

Reference will now be made to FIGS. 1 through 9, which show a first preferred embodiment of the readily controllable skateboard of the present invention, as indicated by general reference numeral 20. The readily controllable skateboard 20 comprises a board means in the form of a single board 30 and is preferably made from layers of wood laminated together, or any other suitable material. The material must be strong enough to support the weight of a rider under dynamic load conditions, yet must be flexible enough to allow for the absorption of impact and to permit control of the skateboard 20 through various movements, as is well known in the art.

The board 30 has a top surface 31, a bottom surface 32, a left side edge 33, a right side edge 34, a front end 35 and a back end 36. A longitudinal axis “A” extends between the front end 35 and the back end 36. The length “L” of the board 30 is defined as extending from the front end 35 to the back end 36. The width “W” of the board 30 is defined as extending from the left side edge 33 to the right side edge 34.

A front wheel carriage 40 having wheels 42 is mounted in downwardly extending relation on the bottom surface 32 of the board 30 adjacent the front end 35 thereof by means of suitable threaded fasteners 44. Similarly, a rear wheel carriage 50 having wheels 52 is mounted in downwardly extending relation on the bottom surface 32 of the board 30 adjacent the back end 36 thereof by means of suitable threaded fasteners 54.

A connector means preferably comprising a square bend “U”-bolt 60 extends through co-operating apertures 38 having a diameter of about one-quarter inch in the board 30, and is secured to the board 30 be means of co-operating lock nuts 62 and washers 64. The square bend “U”-bolt 60 is generally centrally located along the length “L” and across the width “W” of the board 30. The square bend “U”-bolt 60 is mounted on the skateboard 20 so as to be presented adjacent the bottom surface 32 of the board 30. The connector means may alternatively comprise a bent “eye” bolt, a lag screw, or a conventional “U”-bolt.

A strap means comprises a strap 70 made from Nylon™ or any other suitable material, and having a top end 72 and a bottom end 74. The strap 70 is about three to four feet long and further comprises a handle means 78 connected to the strap 70 at the top end 72 thereof. The strap 70 is removably and replaceably connected adjacent its bottom end 74 to the “U”-bolt 60 by means of a spring biased snap mechanism 76 at its bottom end 74.

The strap 70 extends upwardly from the “U”-bolt 60, and away from the board 30, so as to present the handle means 78 to a rider. The strap 70 permits the rider to ride on the readily controllable skateboard 20 in a stable manner and completely in control. Further, the readily controllable skateboard 20 may be readily lifted for manoeuvres such as jumps and the like.

The readily controllable skateboard 20 further comprises an aperture 80 generally centrally located in the board 30. The aperture 80 is elongate and is preferably about one inch long and about one-half inch across. The aperture 80 accommodates movement of the spring biased snap mechanism 76.

Reference will now be made to FIG. 10, which shows a preferred embodiment of the readily controllable snowboard of the present invention, as indicated by general reference numeral 120. The preferred embodiment readily controllable snowboard 120 comprises a board means in the form of a single board 130 and is preferably made from layers of wood laminated together, or any other suitable material. The material must be strong enough to support the weight of a rider under dynamic load conditions, yet must be flexible enough to allow for the absorption of impact and to permit control of the snowboard 120 through various movements, as is well known in the art.

The board 130 has a top surface 131, a bottom surface 132, a left side edge 133, a right side edge 134, a front end 135 and a back end 136. A longitudinal axis “A” extends between the front end 135 and the back end 136. The length “L” of the board 130 is defined as extending from the front end 135 to the back end 136. The width “W” of the board 130 is defined as extending from the left side edge 133 to the right side edge 134.

A connector means preferably comprising a square bend “U”-bolt 160 extends through co-operating apertures 138 having a diameter of about one-quarter inch in the board 130, and is secured to the board 130 be means of co-operating lock nuts 162 and washers 164. The square bend “U”-bolt 160 is generally centrally located along the length “L” and across the width “W” of the board 130. The square bend “U”-bolt 160 is mounted on the snowboard 120 so as to be presented adjacent the bottom surface 132 of the board 130. The connector means may alternatively comprise a bent “eye” bolt, a lag screw, or a conventional “U”-bolt.

A strap means comprises a strap 170 made from Nylon™ or any other suitable material, and having a top end 172 and a bottom end 174. The strap 170 is about three to four feet long and further comprises a handle means 178 connected to the strap 170 at the top end 172 thereof. The strap 170 is removably and replaceably connected adjacent its bottom end 174 to the “U”-bolt 160 by means of a spring biased snap mechanism 176 at its bottom end 174.

The strap 170 extends upwardly from the “U”-bolt 160, and away from the board 130, so as to present the handle means 178 to a rider. The strap 170 permits the rider to ride on the readily controllable snowboard 120 in a stable manner and completely in control. Further, the readily controllable snowboard 120 may be readily lifted for manoeuvres such as jumps and the like.

The readily controllable snowboard 120 further comprises an aperture 180 generally centrally located in the board 130. The aperture 180 is elongate and is preferably about one inch long and about one-half inch across. The aperture 180 accommodates movement of the spring biased snap mechanism 176.

As can be understood from the above description and from the accompanying drawings, the present invention provides a readily controllable ride-on board, such as a skateboard, snowboard, surfboard, and the like, which is unknown in the prior art.

Other variations of the above principles will be apparent to those who are knowledgeable in the field of the invention, and such variations are considered to be within the scope of the present invention. Further, other modifications and alterations may be used in the design and manufacture of the readily controllable skateboard of the present invention without departing from the spirit and scope of the accompanying claims.

I claim:

1. A readily controllable skateboard comprising:
a board means having a length and a width, and a top surface and a bottom surface;
a front wheel carriage and a rear wheel carriage mounted in downwardly extending relation on the bottom surface of said board means;
connector means secured to said board means so as to be generally centrally located along the length and across the width of said board means; and,
a strap means having a top end and a bottom end, and connected adjacent its bottom end to said connector means so as to be extendable upwardly from said board means.

2. The readily controllable skateboard of claim 1, wherein said connector means is mounted on said board means so as to be presented adjacent the top surface of said board means.

3. The readily controllable skateboard of claim 2, wherein said connector means comprises a “U”-bolt.

4. The readily controllable skateboard of claim 3, further comprising an aperture generally centrally located in said board means, underneath said “U”-bolt.

5. The readily controllable skateboard of claim 4, wherein said strap means is removably and replaceably connected to said “U”-bolt.

6. The readily controllable skateboard of claim 1, further comprising a handle means connected to said strap means at said top end thereof.

7. The readily controllable skateboard of claim 1, wherein said board means comprises a single board.

8. A readily controllable ride-on board comprising:
a board means having a top side and an under side;
connector means secured to said board means so as to be generally centrally located along the length and across the width of said board means; and,
a strap means having a top end and a bottom end, and connected adjacent its bottom end to said connector means so as to be extendable upwardly from said board means.

9. The readily controllable ride-on board of claim 8, wherein said connector means is mounted on said board so as to be presented adjacent the under side of said board means.

10. The readily controllable skateboard of claim 9, wherein said connector means comprises a “U”-bolt.

11. The readily controllable skateboard of claim 10, further comprising an aperture generally centrally located in said board means, underneath said “U”-bolt.

12. The readily controllable skateboard of claim 11, wherein said strap means is removably and replaceably connected to said “U”-bolt.

13. The readily controllable skateboard of claim 1, further comprising a handle means connected to said strap means at said top end thereof.

14. The readily controllable skateboard of claim 1, wherein said board means comprises a single board.
